(19) United States
(12) Patent Application Publication
(10) Pub. No.: US 2010/0174448 A1
(43) Pub. Date: Jul. 8, 2010

(54) Method and device for operating a control unit

(76) Inventors: Bernd Mueller, Leonberg (DE); Markus Ferch, Grossbottwar (DE); Yorck von Collani, Beilstein (DE); Holger Banski, Palo Alto, CA (US)

Correspondence Address: KENYON & KENYON LLP, ONE BROADWAY, NEW YORK, NY, 10004, US

(21) Appl. No.: 12/655,527

(22) Filed: Dec. 30, 2009

(30) Foreign Application Priority Data
Jan. 7, 2009 (DE) 10 2009 000 045.3

(51) Int. Cl. G01M 17/00

(52) U.S. Cl. 701/35; 701/29

(57) ABSTRACT

A control unit has two pairs of execution units, the two execution units of each pair redundantly processing the same program, and the output signals of each execution unit of one pair being compared to one another by a respective comparing unit, the respective comparing unit outputting an error signal when a difference in the output signals of the execution units of one pair occurs. A first pair of execution units are shut down when the error signal occurs for the first pair, and the control unit continues control operation using the second pair of execution units, and a pre-warning signal is output to the driver.

### BACKGROUND OF THE INVENTION

1. Field of the Invention

The present invention relates to a method for operating a control unit in a motor vehicle having a computer system which has two pairs of execution units, the two execution units of each pair processing the same program and the output signals of the execution units of one pair being compared with each other, an error signal being output in the event of a difference in the output signals of the execution units of one pair.

2. Description of Related Art

Published international patent application WO 2007/017381 A1 discloses a device which includes a multiprocessor system having four execution units, two execution units always processing the same tasks and processes. Using a comparing unit, the output signals output by two execution units, which process the same programs, are compared and when these two output signals differ from one another, an error signal is output. This case, referred to as lockstep mode, is primarily used in such applications having high error detection requirements, e.g., in safety-relevant applications.

In the case of an error, in virtually all automotive states the shutdown of a control unit is considered the safest state. If a control unit is shut down, the driver is informed about it, because operation of the vehicle may not continue after the shutdown of the control unit, provided that the control unit is a prerequisite for operating the vehicle (e.g., engine control, steering, etc.).

An object of the present invention is to provide a method and a device for operating a control unit in which operation of the vehicle may continue even in the event of an error.

A method for operating a control unit according to the present invention has the advantage that the driver may continue driving without restrictions. Due to the fact that, when the error signal for a first pair of execution units occurs, the control unit is shut down and the computer system continues to operate using the second pair of execution units and a pre-warning signal is output to the driver, the core function of the control unit being maintained while the driver receives only a warning. This method is always advantageously usable when the two pairs are so-called “lockstep pairs” which means that two execution units of one pair always process the same program steps and the output signals of the two execution units, which form one pair, are compared. The two execution units of one pair may be interconnected asynchronously or with the aid of a clock-pulse offset which is taken into account during the comparison.

No further measures are needed for safeguarding since the normative requirements are still met due to the remaining, still active, lockstep pair. No speed reduction is necessary, for example.

In one embodiment, the computer system is only shut down when error signals occur from both pairs of the execution units and a visual and/or acoustic warning signal is output to the driver. The driver must stop the driving operation of the vehicle immediately, since the safety of the vehicle is no longer ensured. Two-step error signaling is thus made possible. The driver receives a pre-warning signal when one pair of execution units fails, and a warning signal is output if both pairs are defective.

The pre-warning signal is advantageously output during the entire continuing operation of the computer system using the second, still active pair of execution units. The driver is thus informed during the entire remaining driving cycle that a safety-relevant error exists in the control unit. The driver is thus prompted at an early stage to look for a repair shop to have the error corrected.

In one embodiment, the second, still active pair of execution units is informed about the error in the first pair of execution units, the second pair of execution units initiating the output of the pre-warning signal. There is the option that the second pair of execution units may access various units of the computer system, thereby making it possible to use signaling devices which are already present in the vehicle and are not needed during driving operation.

In one refinement, the first pair of execution units is tested after the error has been detected and the pre-warning signal is output to the driver only when the first pair of execution units has been shut down after the error was confirmed. This has the advantage that error signaling to the driver takes place only when it is certain that a hardware error really exists and the first pair of execution units must be shut down. Transient errors, which influence the execution units by EMV effects, radioactive, or cosmic radiation, do not result in error signaling because they do not leave any permanent damage and occur only sporadically.

The occurrence of the error signal is advantageously counted and the pre-warning signal is only output when a predefined number of error signals has been ascertained. A signal is not triggered at the first occurrence of an error signal, because it is not certain in this case whether a permanent error really exists. In this way, the pair which is affected by transient errors may return to its normal processing state after the cessation of the transient errors. Disturbing of the driver by a premature error display is thus prevented. In one embodiment, the error signal is memorized, the first pair of execution units being tested at a restart of the computer system and the pre-warning signal being suppressed when the error signal fails to occur. The computer system is restarted normally when the vehicle engine is started, i.e., in a new driving cycle. After the shutdown pair of execution units is regenerated during the vehicle standstill or a vehicle reset, a warning to the driver may be omitted.

In one refinement, the computer system is shut down despite correct mode of operation of the second pair of execution units when the number of memorized error signals exceeds a certain value. The memorized error signals indicate the vulnerability of the computer system. If a certain number of faults are registered, the control unit must be tested in a repair shop for possibly sporadically occurring hardware errors in order to prevent permanent failure of both pairs of execution units.

In another refinement, a device for operating a control unit in a motor vehicle has a computer system which includes two pairs, each having two execution units, the two execution units of each pair processing the same program and the output signals of each execution unit of one pair being compared with one another using one comparing unit each, an error signal being output by the comparing unit when a difference in the output signals of the execution units of one pair occurs. In a device where operation of the vehicle may continue also in the event of an error, means are present which, when the error signal for a first pair of execution units occurs, shuts it down and continues to operate the computer system using the second pair of execution units, a pre-warning signal being output to the driver. Although the full operability of the computer system is reliably ensured due to the presence of the second pair of execution units, which additionally processes at least part of the programs of the execution units of the first pair, the damage to the first pair of execution units is indicated to the driver for safety reasons.

The comparing units are advantageously connected to a signaling device which is associated with the defective pair of execution units and which is activated when the comparing unit outputs the error signal. Immediately after the error is detected, the driver is informed so he is able to initiate countermeasures if needed.

In one embodiment, the comparing unit of the first pair and the comparing unit of the second pair are connected to a holding element which is connected to the signaling device. Via the holding element, the signaling device is activated by the error signal of at least one comparing unit and kept active during the entire driving cycle of the vehicle, so that the driver is continuously informed about the error. One holding element is sufficient here which may be activated by both comparing units.

In one refinement, the signaling device is contained in a second control unit, the first and the second pair of execution units being connected to the second control unit via a data line and the second, still active pair of execution units, transmitting a signal to the second control unit for activating the signaling device following information from the first pair about the output of an error signal. In this case, communication of the two control units takes place which is initiated in the first control unit by the second, still active pair of execution units. The information of the second, still active pair of execution units about the error in the first pair of execution units is provided via an interrupt or via a signal to be cyclically checked.

The signaling device is alternatively situated in a peripheral unit of the computer system which is connected to the first and the second pair of execution units via a data line, and the second, still active pair of execution units transmits a signal to the peripheral unit for activating the signaling device after having received information about the output of an error signal by the first pair. Signaling devices may thus be used which are advantageously already present in the vehicle and which are connected to other devices of the computer system and are not in use during the driving operation of the vehicle.

In one refinement, a memory unit containing a counter is connected to the data line, the counter being incremented by a certain value when the error signal is output by one of the two comparing units and the signaling device is only activated by the counter when a predefined counter value is reached. To prevent transient errors from occurring and to be sure that a hardware fault which is permanently repeated is present, the driver is alerted only when a predefined counter value is reached.

An error memory of the control unit is advantageously connected, via the data line, to the first and the second execution units in which an entry is made at each activation of the signaling device. With the aid of such an error memory, the behavior of both pairs of execution units may be continuously registered and may be read out and interpreted at any time. These error entries may be deleted only in a repair shop.

In one embodiment, the control unit is permanently shut down when the number of error entries in the error memory is exceeded. This measure ensures that a vehicle unsuitable for driving, which does not meet the prevailing safety requirements, is not operated. Even if it is not definitely known which errors resulted in the entries in the error memory, it must be assumed that, starting from a predefined number of error entries which have been registered either currently or within a certain period, the vehicle's safety is no longer ensured.

### BRIEF DESCRIPTION OF THE SEVERAL VIEWS OF THE DRAWING

FIG. 1 shows a first exemplary embodiment of the device according to the present invention.

FIG. 2 shows a schematic program flow chart for the device according to FIG. 1.

FIG. 3 shows a second exemplary embodiment of the device according to the present invention.

FIG. 4 shows a schematic flow diagram for the device according to FIG. 3.

FIG. 5 shows a third exemplary embodiment of the device according to the present invention.

FIG. 6 shows a fourth exemplary embodiment of the device according to the present invention.

### DETAILED DESCRIPTION OF THE INVENTION

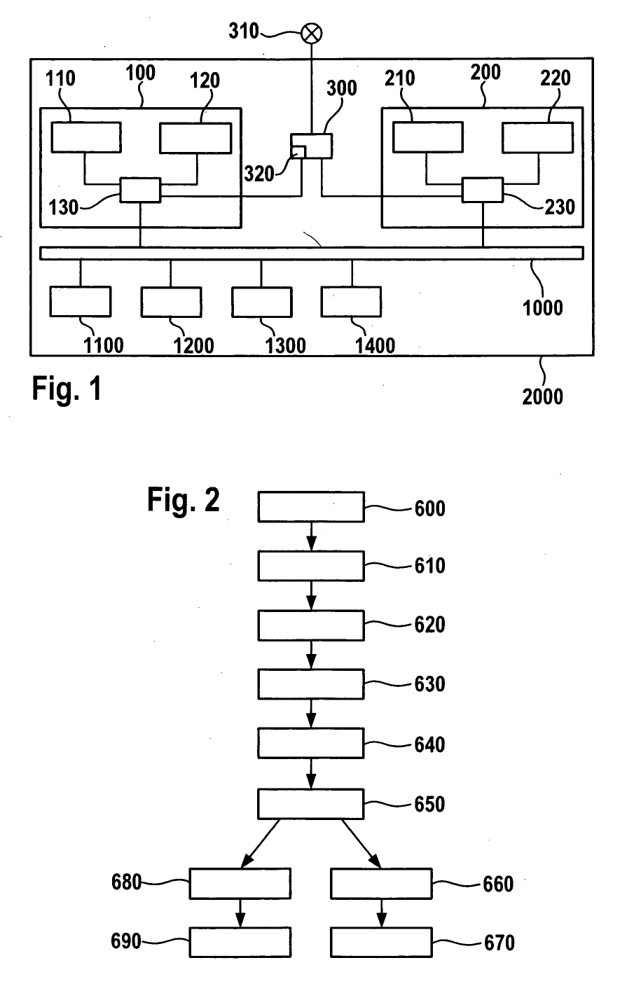

FIG. 1 shows a control unit 2000 for a motor vehicle which includes a computer system having four computing units 110, 120, 210, 220. Two [of the four] computing units 110, 120, 210, 220 are combined in a pair 100, 200. Computing units 110, 120 form pair 100 and computing units 210, 220 form pair 200.

Computing units 110, 120 of first pair 100 are connected to a first comparing unit 130, while computing units 210, 220 of second pair 200 are connected to a second comparing unit 230. First comparing unit 130 and second comparing unit 230 are connected to a communication line 1000. A memory 110 and additional peripheral units 1200, 1300, and 1400 are connected to communication line 1000.

Furthermore, comparing units 130, 230 of both pairs 100, 200 are connected to a holding element 300 which in turn is connected to a warning device 310. Warning device 310 includes two lamps, one yellow and one red.

In addition, a counter 320 is contained in holding element 300 which registers the error signals of both comparators 130, 230. However, two counters may also be provided where one counter is fixedly associated with one comparing unit and counts its error signals.

The mode of operation of this device is described with the aid of FIG. 2. In block 600, each pair 100, 200 operates in a lockstep mode. This means that both computing units 110, 120, and 210, 220 of pair 100, 200 simultaneously process the same programs, comparing units 130, 230 of each pair 100, 200 comparing the output signals of both computing units 110, 120; 210, 220, respectively. In the event of differences between the two output signals, the respective comparing unit 130, 230 outputs an error signal. This mode is also known as comparing mode.

However, it is also possible that the programs, which are processed in both computing units 110, 120; 210, 220 of a pair 100, 200, have a clock-pulse offset in the comparing mode or are themselves implemented asynchronously. Such clock-pulse offset or such asynchronicity is known to comparing units 130, 230 associated with both computing units 110, 120 and 210, 220 and is reset before the actual comparison takes place. Comparing units 130, 230 may thus contain memories for enabling asynchronicity or may process control signals which inform whether a comparison for a certain computing result is to be carried out, since not all computing results in comparator 130, 230 communicated via the output signals have to necessarily be compared with one another.

If a comparison error is detected in block 610 by a comparator 130, 230 then a signal is output to holding element 300 by comparator 130, 230. Counter 320 is incremented in block 620. If the counter value of counter 320 is below a predefined value, which is checked in block 630, then control unit 2000 continues to operate unchanged, the counter value of counter 320 being incremented by the value one with each error message. If it is detected in block 630 that the counter value has reached or exceeded the predefined value, then holding element 300 is activated in block 640.

It is checked in block 650 whether one comparing unit 130 or 230 or both comparators 130, 230 have output an error signal to holding element 300. If it is detected that the error signal is output by only one comparator 130, 230 then the yellow light of warning device 310 is activated in block 660 and pair 100, 200 of computing units 110, 120 or 210, 220, which is connected to comparing unit 130, 230 indicating the error, is deactivated. The warning device remains in operation during the entire ongoing drive cycle of the motor vehicle, since holding element 300 sets the signal permanently. The yellow light is used for informing the driver of the motor vehicle that an error has occurred and he is supposed to look for a repair shop. The current driving operation of the motor vehicle is not affected by this since the second, still active pair 100, 200 continues to ensure operation either with curtailed functionality or, after an error-free test of the still active pair 100, 200, with full functionality (block 670).

If, however, it is detected in block 650 that both comparators 130, 230 have output an error message, then the red light of warning device 310 is activated in block 680. Control unit 2000 is shut down in this case and the driver must stop the driving operation because of safety considerations in block 690.

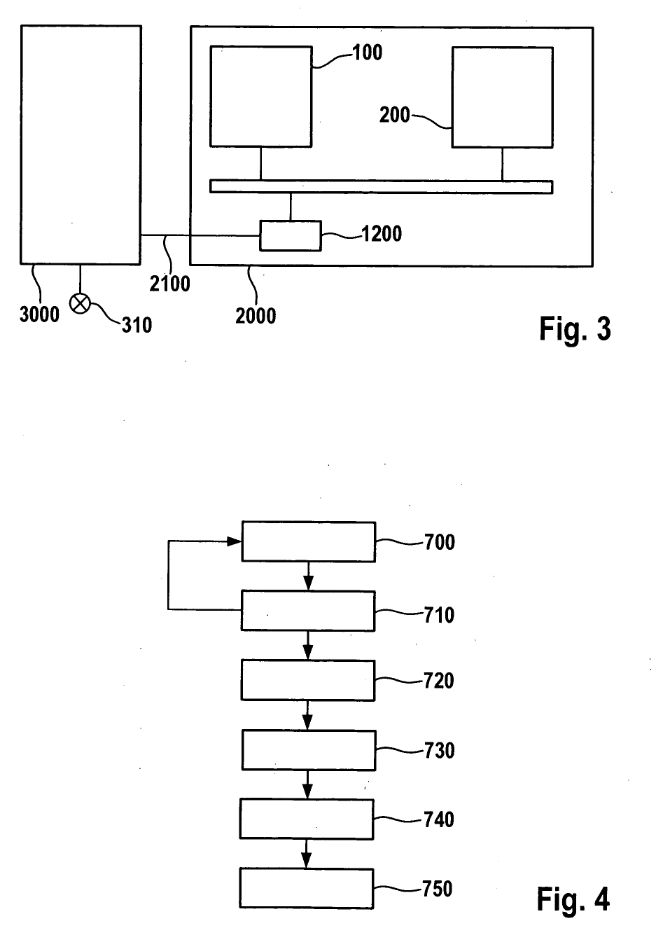

FIG. 3 shows a modified exemplary embodiment. As in FIG. 1, control unit 2000 includes two pairs 100, 200, each having two computing units which are not further depicted. Both pairs 100, 200 are connected to internal communication line 1000 which is connected to the on-board CAN bus 2100 via an interface 1200. Via CAN bus 2100, control unit 2000 communicates with another control unit 3000 which has warning device 310.

According to FIG. 4, both pairs 100 and 200 operate in block 700 in the comparing mode as has been described above. If an error is detected by pair 100, 200 in block 710, then a signal is output to the second, error-free operating pair 100, 200 via communication line 1000. This pair 100, 200 detects that first pair 100, 200 indicates an error. A hardware test of the erroneous pair 100 of computing units 110, 120 in the form of a self-test is triggered in block 720. If the hardware test recognizes an error, then the erroneous pair 100 is shut down in block 730. Only after the erroneous pair has been shut down is a signal output in block 740 by second pair 200 to second control unit 3000 via communication line 1000, interface 1200, and CAN bus 2100. After having received the signal in block 750, control unit 3000 activates the yellow light of warning device 310.

If no error is detected in block 720, the computer system returns to the comparing mode as it is executed in block 700.

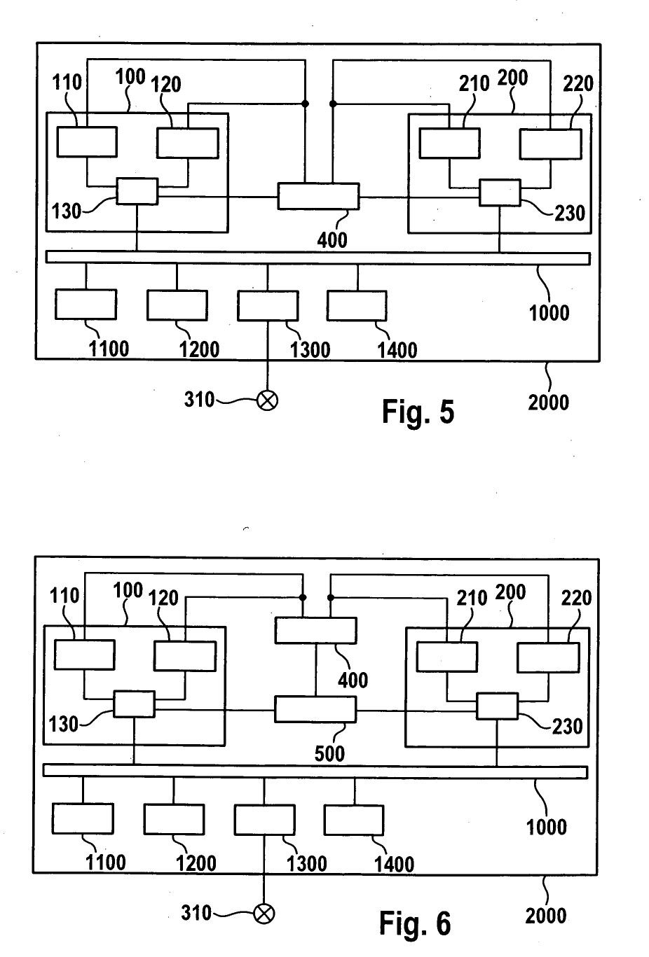

Possibilities of communicating to pairs 100, 200 of computing units 110, 120; 210, 220 within control unit 2000 that one pair 100, 200 operates erroneously are illustrated in FIGS. 5 and 6.

In FIG. 5, both comparators 130, 230 of each pair 100, 200 of computing units 110, 120; 210, 220 are connected to an interrupt controller 400 which is connected to computing units 110 and 120 of pair 100 as well as to computing units 210 and 220 of pair 200. If, for example, comparator 130 of pair 100 detects an error in the processes of computing units 110 or 120, an error signal is output to interrupt controller 400. This interrupt controller initiates an interrupt in computing units 210 and 220 of pair 200, thereby indicating to them that an error is present in pair 100. Based on such an interrupt, pair 200 outputs a signal which reaches CAN bus 2100 via communication line 1000 and interface 1200 and from there it is conveyed to control unit 3000 for activating warning device 310.

As illustrated in FIG. 5, warning device 310 may also be situated on a peripheral unit 1300 of control unit 2000. Also in this embodiment, after it is informed by the interrupt about the non-operability of pair 100, pair 200 outputs a signal which is conveyed via internal communication line 1000 of control unit 2000 to peripheral unit 1300 which in turn keeps the yellow light of warning device 310 operating as long as the current drive cycle of the vehicle continues.

Alternatively, a counter (not further depicted), which is situated in memory 1100, for example, may be incremented by the error-free operating pair 200 while the erroneous pair 100 is restarted after a successful hardware test. Only when the counter content of the counter contained in memory 1100 has reached a predefined value, i.e., when a comparison error has occurred multiple times in pair 100, is the yellow light of warning device 310 activated.

According to FIG. 6, comparators 130, 230 of pairs 100, 200 are connected to an additional hardware unit 500 which in turn is connected to interrupt controller 400. In this embodiment, the error is signaled indirectly via additional hardware unit 500 which outputs the error signal to interrupt controller 400 for triggering the interrupt in computing units 210 and 220 of pair 200. Here also, the interrupt is used for informing computing units 210 and 220 that computing units 110, 120 of pair 100 are not operating properly. Pair 200 thereupon triggers the signal for activating warning device 310.

Information about the faultiness of a pair 100, 200 may alternatively be obtained via a signal which is cyclically checked.

An error memory 1400 of control unit 2000 is shown in FIGS. 1, 5, and 6 in which an error is entered at each activation of warning device 310. This error entry is permanently stored and remains stored even after termination of the drive cycle in which the error entry took place. At a restart of the vehicle, the pair indicated as defective is subject to a hardware test. If this hardware test does not detect any error of pair 100 then the warning signal to be output by warning device 310 is suppressed. The error entry may be deleted by the repair shop at any time.

If, however, the absolute error number or a number of errors occurring during a certain period has exceeded a certain value, control unit 2000 is permanently shut down irrespective of pair 200 still operating error-free.

What is claimed is:

1. A method for operating a control unit of a motor vehicle, the control unit having a first pair of execution units and a second pair of execution units, comprising:
redundantly executing the same program by the first and second pairs of execution units in parallel, wherein the two execution units of each pair redundantly process the same program in parallel;
comparing, for each pair of execution units, output signals of the two execution units of the pair to one another;
generating an error signal if a difference in the output signals of the two execution units of a pair occurs; and
if an error signal is generated, performing the following: (a) stopping operation of the pair of execution units generating the error signal; (b) continuing further operation of the pair of execution units not generating the error signal; and (c) outputting a pre-warning signal to a driver of the motor vehicle indicating an existence of an error in the control unit.

2. The method as recited in claim 1, wherein, if error signals are generated from both the first and second pairs of execution units, the control unit is shut down and a corresponding warning signal is output to the driver.

3. The method as recited in claim 1, wherein, during the entire period of continuing further operation of the pair of execution units not generating the error signal, the pre-warning signal is output by the pair of execution units not generating the error signal second.

4. The method as recited in claim 3, wherein the pair of execution units not generating the error signal is informed about the error signal by the pair of execution units generating the error signal.

5. The method as recited in claim 3, wherein the pair of execution units generating the error signal is tested after the error signal is generated, and the pre-warning signal is output to the driver only after (i) the error signal is confirmed by the test and (ii) the pair of execution units generating the error signal is shut down following the confirmation of the error signal by the test.

6. The method as recited in claim 3, wherein the number of occurrences of the error signal is counted and the pre-warning signal is output only when a predefined number of error signals has been detected.

7. The method as recited in claim 3, wherein the generated error signal is stored, and upon restart of the control unit, the pair of execution units which generated the error signal is tested, and the pre-warning signal is suppressed when the error signal fails to occur in the test.

8. The method as recited in claim 7, wherein the control unit is shut down when the number of stored error signals exceeds a predefined value.

9. A control unit for a motor vehicle, comprising:
a first pair of execution units configured to redundantly execute a first program in parallel;
a second pair of execution units configured to redundantly process the first program in parallel, wherein the first and second pairs of execution units redundantly execute the first program in parallel;
a first and second comparison units respectively assigned to the first and second pairs of execution units and configured to (i) compare, for the respectively assigned pair of execution units, output signals of the two execution units of the pair to one another, and (ii) generate an error signal if a difference in the output signals of the two execution units of the pair occurs; and
an arrangement configured to perform the following if an error signal is generated for at least the first pair of execution units: (a) stopping operation of the first pair of execution units generating the error signal; (b) continuing further operation of the second pair of execution units not generating the error signal; and (c) outputting a pre-warning signal to a driver of the motor vehicle indicating an existence of an error in the control unit.

10. The control unit as recited in claim 9, wherein the first and second comparison units are connected to a signaling device, and wherein the signaling device is configured to be activated when an error signal is generated by at least one of the first and second comparison units.

11. The control unit as recited in claim 10, wherein the first and second comparison units are connected to a holding element, and wherein the holding element is connected to the signaling device.

12. The control unit as recited in claim 11, wherein the signaling device is contained in a further control unit, and wherein the first and second pairs of execution units are connected to the further control unit by a data line, and after the generation of an error signal by the first pair of execution units, the second pair of execution units not generating an error signal transmits an activation signal to the further control unit for activating the signaling device.

13. The control unit as recited in claim 11, wherein the signaling device is situated in a peripheral unit, and wherein the peripheral unit is connected to the first and second pairs of execution units by the data line, and after the generation of an error signal by the first pair of execution units, the second pair of execution units not generating an error signal transmits an activation signal to the peripheral unit for activating the signaling device.

14. The control unit as recited in claim 13, wherein a memory unit containing a counter is connected to the data line, the counter being incremented by a predefined value when the error signal is output by one of the first and second comparison units, and the signaling device activated by the counter only when a predefined counter value is reached.

15. The control unit as recited in claim 13, wherein an error memory is connected by the data line to the first and second pairs of execution units, and wherein an entry is made in the error memory upon each activation of the signaling device.

16. The control unit as recited in claim 15, wherein the control unit is shut down when the number of error entries exceeds a predefined limit in the error memory.
